(19) United States
(12) Patent Application Publication
(10) Pub. No.: US 2016/0226364 A1
(43) Pub. Date: Aug. 4, 2016

(54) Electric Hair Clipper/Trimmer

(71) Applicant: Sunbeam Products, Inc., Boca Raton, FL (US)

(72) Inventor: Richard N. Eubanks, Murfreesboro, TN (US)

(73) Assignee: Sunbeam Products, Inc., Boca Raton, FL (US)

(21) Appl. No.: 15/005,349

(22) Filed: Jan. 25, 2016

Related U.S. Application Data
(60) Provisional application No. 62/109,649, filed on Jan. 30, 2015.

(51) Int. Cl. H02K 33/02; H02P 25/032; H02K 5/04; B26B 19/06; B26B 19/28

(52) U.S. Cl. CPC H02K 33/02; B26B 19/06; B26B 19/282; H02K 5/04; H02P 25/032

(57) ABSTRACT

An electric hair clipper having an electromagnetic motor with a fixed coil and a vibrating armature. The vibrating armature has a fixed end and a free end. A blade set is included having fixed blade and a reciprocating blade, where the reciprocating blade is connected to the free end of the vibrating armature. A spring element is connected to the free end of the armature. The vibrating armature has an armature spring rate and the spring element has a variable spring rate. The armature spring rate and the variable spring rate combine to control the movement of the reciprocating blade by varying the amount of energy absorbed by the vibrating armature and the spring element.

### CROSS-REFERENCE TO RELATED APPLICATION

The present invention claims priority to U.S. Provisional Application No. 62/109,649 entitled ELECTRIC HAIR CLIPPER/TRIMMER, filed on Jan. 30, 2015, the contents of which are herein incorporated by reference in its entirety.

### FIELD OF THE INVENTION

The invention relates generally to electric hair clippers/trimmers, and, more particularly, to an electric hair clipper/ trimmer having an electromagnetic motor.

### BACKGROUND OF THE INVENTION

Vibrator electromagnetic motors have been used in electric hair clippers for many years. Conventional vibratory electromagnetic motors have an electromagnet comprising a coil and associated core energized by a current of fixed frequency. A vibratory armature, mounted in spaced, effective relation with the core, can be connected to a work element as for example the reciprocating blade of a hair clipper. The armature, which forms a part of the magnetic circuit of the electromagnet, moves (vibrates or oscillates) in response to the varying magnetic field of the electromagnet, the permeability of the magnetic circuit varying with the travel path of the armature.

### SUMMARY OF THE INVENTION

The present invention provides electric hair clipper including an electromagnetic motor with a fixed coil and a vibrating armature. The vibrating armature has a fixed end and a free end. A blade set is having fixed blade and a reciprocating blade are included, where the reciprocating blade is connected to the free end of the vibrating armature. A spring element can also be connected to the free end of the armature.

The vibrating armature has an armature spring rate and the spring element has a variable spring rate. The spring element can have a first spring rate through a first distance of travel of the free end of the vibrating armature and a second spring rate through a second distance of travel of the free end of the vibrating armature, wherein the first spring rate is less than the second spring rate.

The armature spring rate and the variable spring rate combine to control the movement of the reciprocating blade by varying the amount of energy absorbed by the vibrating armature and the spring element. The combination of the vibrating armature and the spring element can absorbed less energy at a minimum deflection point and more energy at maximum deflection point of the free end of the vibrating armature, when compared to a standard vibrating armature.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a top isometric view of the electric clipper of the present disclosure;

FIG. 2 depicts a top isometric sectional view of the electric clipper of FIG. 1;

FIG. 3. depicts a top isometric sectional view of the front portion of the electric clipper of FIG. 1

FIG. 4 depicts a front cross sectional view of the electric clipper of FIG. 1;

FIG. 5 depicts a front isometric cross sectional view of the electric clipper of FIG. 1;

FIG. 6 depicts and energy absorption table fir the electric clipper with a variable spring rate spring element.

### DETAILED DESCRIPTION OF THE INVENTION

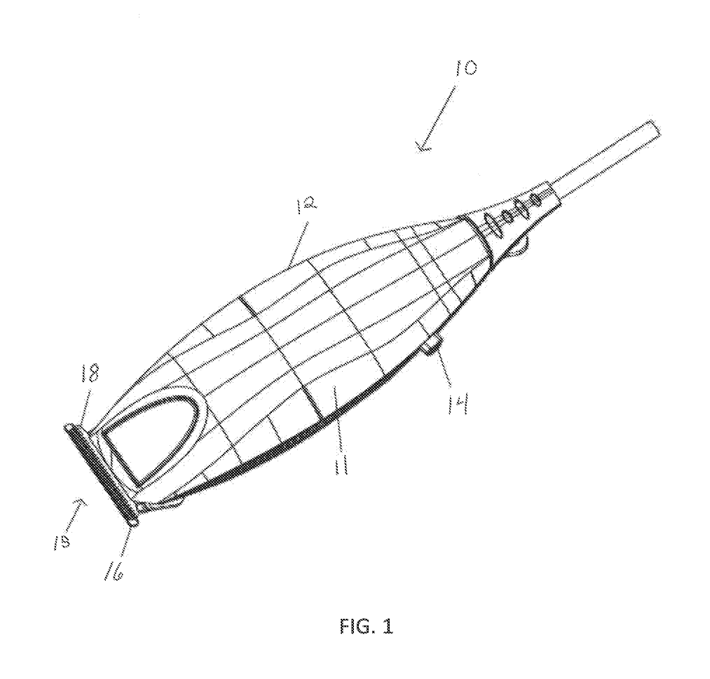

Referring now to the drawings and, more particularly, to FIG. 1, a top elevation view of an electric hair cutting apparatus 10 according to the teachings of the present invention is shown. Electric hair cutting apparatus 10 includes a housing 12 which is generally hollow and houses the internal workings of the apparatus 10. A manual switch 14 is provided for turning the apparatus 10 on and off. At one end of the apparatus 10 is a blade set 15, include a fixed blade 16 and a reciprocating blade 18, as is known in the art. The reciprocating blade 18 oscillates back and forth, left and right, so as to cut hair which enters between the teeth of the blades 16, 18.

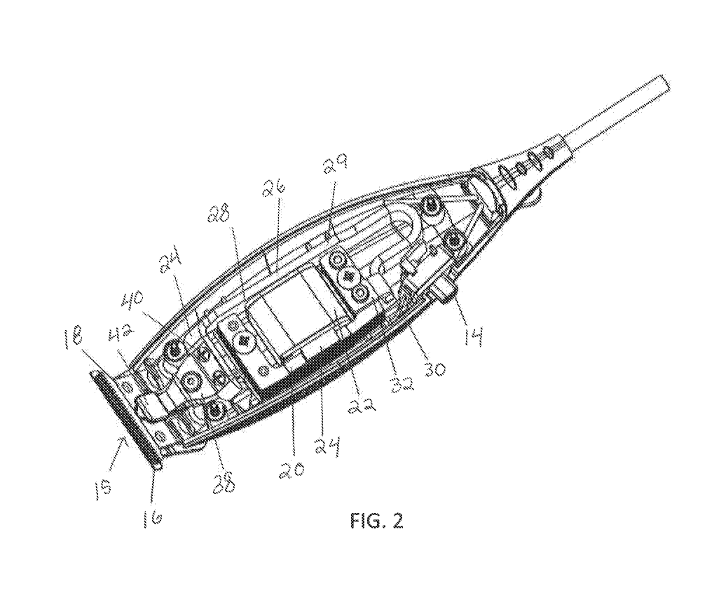

FIG. 2 is a 10 elevation view similar to FIG. 1, but with one side 11 of housing 12 removed for better viewing of the internal workings of the apparatus 10. As can be seen, housing 12 houses a conventional vibratory electromagnetic motor 20 having a fixed coil 22 and a pole piece or core 24. A vibratory armature 26 is disposed in effective relation with core 24, an air gap 28 being present between the core 24 and armature 26.

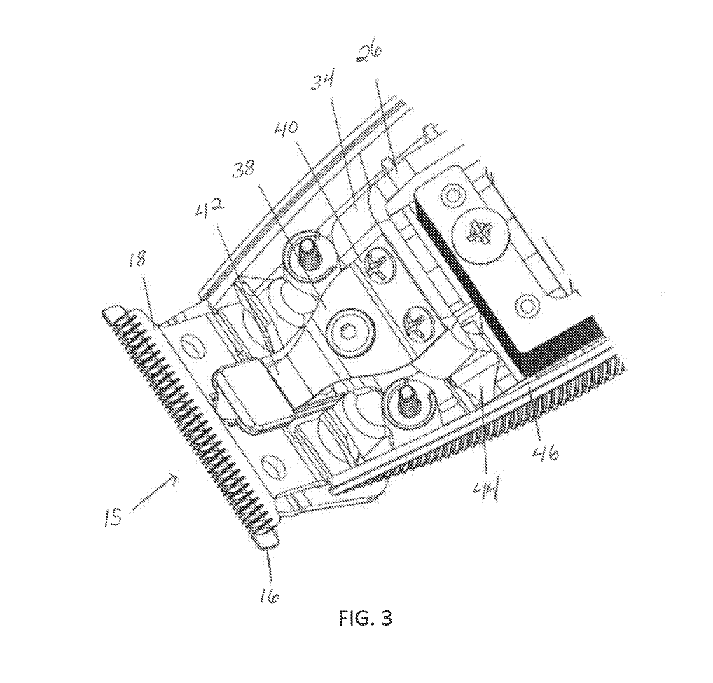

The vibrating armature 26 includes a resilient or elastic arm 28 which is anchored at one end 30 to a fixed support 32, where in the vibrating armature 26 has an armature spring rate Aₛᵣ at a connection point. Referring also to FIG. 3, an opposite, free, end 34 of vibrating armature 26 is free to movie in a reciprocating motion upon activation of the electromagnetic motor 20. A drive tip 38 is affixed to the free end 34 of the armature 26 at one end 40, where an opposite end 42 of the drive tip 38 is connected to the reciprocating blade 18 of the bade set 15.

Actuation of switch 14, applies AC power to the fixed coil 22, 60 Hertz line voltage is suitable, although square waves or any other suitable inductance inducing current would also work. The current in the fixed coil 22 produces magnetic flux which flows through the fixed coil 22, vibrating the armature 26 across the air gap 28. The vibrating armature 26 reciprocate back and forth as the coil 22 current changes direction, moving the reciprocating blade 18 over the fixed blade 16 of the blade set 15, cutting the hair which is there between.

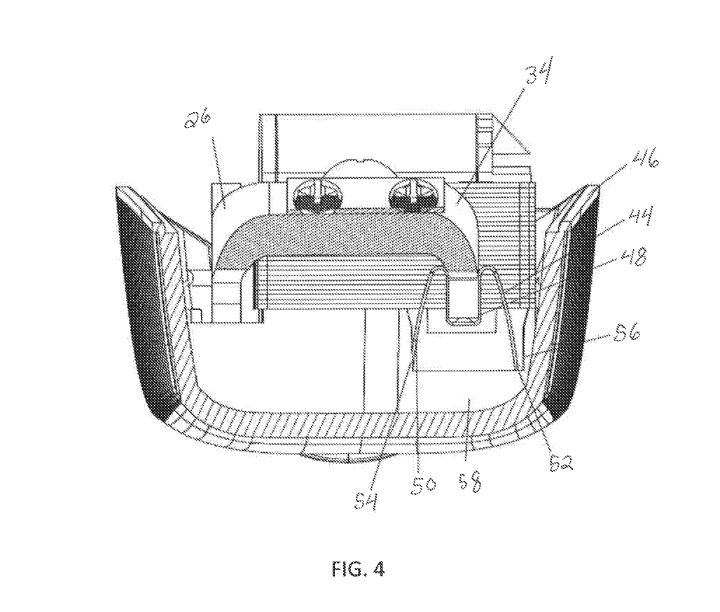

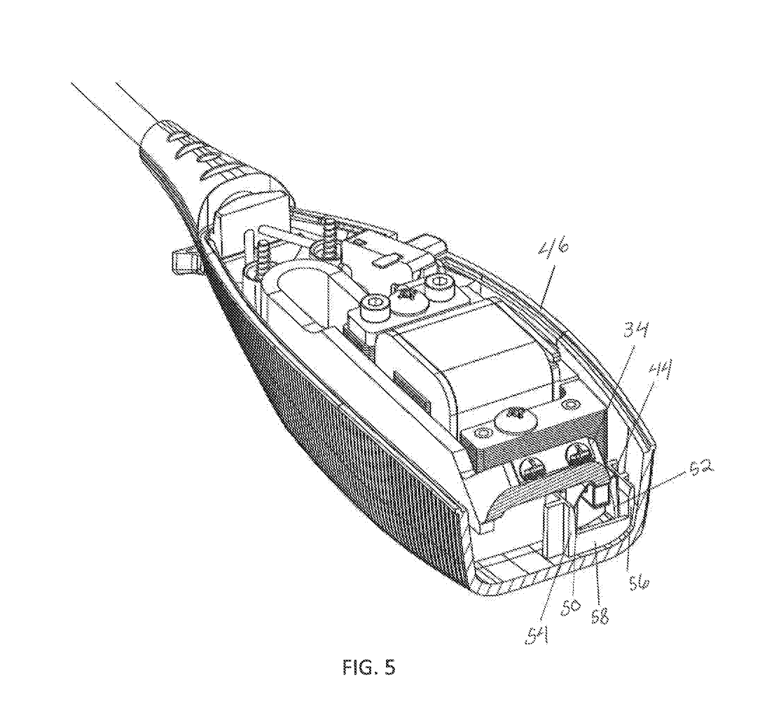

Referring also to FIGS. 4-6, a spring element 44 is connect between the free end 34 of the vibrating armature 26 and the second side housing 46 of the clipper housing 10. In an embodiment, the spring element 44 is substantially U-shaped, having a center indented portion. 48 couples to the free end 34 of the vibrating armature 26. The ends 50, 52 of the spring element 44 can be constrained by side wall 54 and 56 of the spring retainer 58 on the second side housing 46 of the clipper housing 10.

The spring element 44 can have a variable spring rate Sₛᵣ. The spring rate Sₛᵣ of the spring element 44 can increase with the travel distance of the armature 26. The increase in the spring rate can be a non-linear rate increase, for example, a non-linear step or exponential function. The non-linear increase in the spring rate can limit the sweep distance of the moving blade 18, as well as, provide better control thereof.

In operation, the armature spring rate Aₛᵣ and the variable spring rate Sₛᵣ combine to control the movement of the moveable blade 18 by varying the amount of energy absorbed by the vibrating armature 26 and the spring element 44. The combination of the vibrating armature 26 and the spring element 44 can absorbed less energy at a minimum deflection point and more energy at maximum deflection point of the free end 34 of the vibrating armature, when compared to a standard vibrating armature.

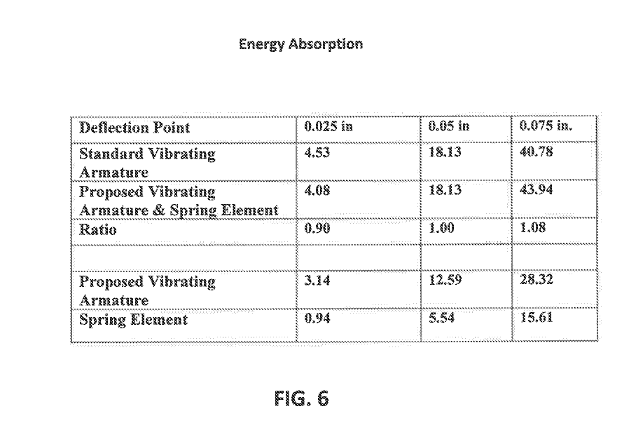

In an embodiment, a standard vibrating armature can be 3 mm in thickness, with an armature spring rate Aₛᵣ of 145 lb/inch at the connection point. The proposed vibrating armature 26 can be 12 gage in thickness, with a proposed armature spring rate Aₛᵣ of 101 lb/inch at the connection point. The spring element 44 is connection to the end the proposed vibrating armature 26, where the spring element 44 can have a variable spring rate Sₛᵣ of about 30 lb/in for the first 0.025 inches of travel of the free end 34 and 87 lb/in from 0.025-0.075 inches of travel of the free end. Referring to FIG. 6, the combination of the proposed vibrating armature 26 and the spring element 44 can absorb about 10% less energy at the minimum deflection point and about 10% more energy at the maximum deflection point that a standard vibrating armature. In this manner, the combination of the proposed vibrating armature 26 and the spring element 44 can provide better control over the movement of the reciprocating blade 18 then a standard vibrating armature. Note that the above noted travel distances and spring rates are exemplary in nature, and others travel distances and spring rates are contemplated.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A electric hair clipper comprising a:
an electromagnetic motor including a fixed coil and an vibrating armature, wherein the vibrating armature has a fixed end and a free end;
a blade set including a fixed blade and a reciprocating blade, wherein the reciprocating blade is connected to the free end of the vibrating armature; and
a spring element connected to the free end of the armature.

2. The electric hair clipper as set forth in claim 1, wherein the vibrating armature has an armature spring rate and the spring element has a variable spring rate.

3. The electric hair clipper as set forth in claim 2, wherein the spring element has a first spring rate through a first distance of travel of the free end of the vibrating armature and a second spring rate through a second distance of travel of the free end of the vibrating armature.

4. The electric hair clipper as set forth in claim 3, wherein the first spring rate is less than the second spring rate.

5. The electric hair clipper as set forth in claim 2, further comprising a housing, wherein the electromagnetic motor is positioned in the housing, and at least on end of the spring element is connected to the housing.

6. A method for controlling the motion of a reciprocating blade in an electric hair, comprising,
providing an electric hair clipper including a housing, and an electromagnetic motor having a fixed coil and an vibrating armature, wherein the vibrating armature has a fixed end and a free end;
providing a blade set connected an end of the housing, the blade set including a fixed blade and the reciprocating blade, wherein the reciprocating blade is connected to the free end of the vibrating armature; and
connecting a spring element to the free end of the armature, wherein at least one end of the spring end is connected to the housing.

7. The method for controlling the motion of a reciprocating blade in an electric hair as set forth in claim 6, wherein the spring element has a first spring rate through a first distance of travel of the free end of the vibrating armature and a second spring rate through a second distance of travel of the free end of the vibrating armature.

8. The method for controlling the motion of a reciprocating blade in an electric hair as set forth in claim 8, wherein the first spring rate is less than the second spring rate.
